(19) United States
(12) Patent Application Publication
(10) Pub. No.: US 2022/0315741 A1
(43) Pub. Date: Oct. 6, 2022

(54) RUBBER COMPOSITION AND USE THEREOF

(71) Applicants: TOYODA GOSEI CO., LTD., Kiyosu-shi (JP); ASM INC., Kashiwashi (JP)

(72) Inventors: Takanori NAKAI, Kiyosu-shi (JP); Hideki TAMAI, Kiyosu-shi (JP); Hiromitsu TAKEUCHI, Kiyosu-shi (JP); Makoto ISHIDA, Kiyosu-shi (JP); Hideyuki IMAI, Kiyosu-shi (JP); Katsunari INOUE, Kashiwashi (JP)

(21) Appl. No.: 17/689,468

(22) Filed: Mar. 8, 2022

(30) Foreign Application Priority Data
Mar. 24, 2021 (JP) 2021-050819

(51) Int. Cl. C08L 9/00

(52) U.S. Cl. CPC C08L 9/00; C08L 2312/00; C08L 2203/20

(57) ABSTRACT

A rubber composition in which a diene rubber containing hydroxyl groups and a polyrotaxane containing a hydrocarbon-modified cyclodextrin as cyclic molecules are urethane-crosslinked by an isocyanate that is a crosslinking agent.

### TECHNICAL FIELD

The present invention relates to rubber compositions containing a polyrotaxane and uses thereof such as a dielectric sheet, sensor, and actuator using the same.

### BACKGROUND ART

Polyrotaxanes are molecular assemblies having a structure in which cyclic molecules are relatively slidably threaded onto linear molecules and the cyclic molecules are prevented from dethreading by stopper groups at both ends of the linear molecules. A polyrotaxane is also called “slide-ring material.” Various types of cyclic molecules and linear molecules are known, but cyclodextrins are often used as the cyclic molecules, and polyethylene glycols are often used as the linear molecules (Patent Documents 1, 2).

Crosslinked polyrotaxanes obtained by crosslinking polyrotaxanes are expected as a material for actuators etc. due to their high permittivity and unique mechanical properties such as viscoelasticity (Patent Document 3).

However, since actuators are used under high voltage conditions, insulation performance tends to degrade if the material of a dielectric layer contains air bubbles or water molecules having a different permittivity. Especially, cyclodextrins and polyethylene glycols have high water absorption. Accordingly, if a dielectric layer is made of a crosslinked polyrotaxane containing cyclodextrin and polyethylene glycol, the dielectric layer has lower moisture resistance, and the insulation performance degrades due to a hydrolysis reaction etc.

The applicants proposed a crosslinked polyrotaxane that contains a block polymer containing a polysiloxane etc. to make it difficult for water molecules to be mixed in the crosslinked polyrotaxane and to improve moisture resistance (Patent Document 4). However, there is still room for improvement.

### CITATION LIST

### Patent Documents

Patent Document 1: International Publication No. WO 2005/080469

Patent Document 2: International Publication No. WO 2008/108411

Patent Document 3: Japanese Unexamined Patent Application Publication No. 2011-241401 (JP 2011-241401 A)

Patent Document 4: Japanese Unexamined Patent Application Publication No. 2017-066318 (JP 2017-066318 A)

### SUMMARY OF INVENTION

### Technical Problem

It is an object of the present invention to make it difficult for water molecules to be mixed in a rubber composition containing a polyrotaxane and a use thereof, and thus to reduce occurrence of a hydrolysis reaction etc. and degradation in insulation performance and improve moisture resistance.

### Solution to Problem

### [1] Rubber Composition

A rubber composition in which a diene rubber containing hydroxyl groups and a polyrotaxane containing a hydrocarbon-modified cyclodextrin as cyclic molecules are urethane-crosslinked by an isocyanate that is a crosslinking agent.

### Functions

A polyrotaxane was not miscible with a diene rubber until a cyclodextrin that is cyclic molecules of the polyrotaxane was modified with a hydrocarbon. As a result, water molecules are less likely to be mixed in the rubber composition containing the polyrotaxane due to hydrophobicity of the diene rubber, and occurrence of a hydrolysis reaction etc. and degradation in insulation performance can be reduced. Moisture resistance is therefore improved.

### [2] Dielectric Sheet

A dielectric sheet made of the rubber composition of [1].

### [3] Actuator

An actuator using the dielectric sheet of [2].

### [4] Sensor

A sensor using the dielectric sheet of [2].

### Advantageous Effects of Invention

The present invention has the following advantageous effects. Water molecules are less likely to be mixed in a rubber composition containing a polyrotaxane and a use thereof. Occurrence of a hydrolysis reaction etc. and degradation in insulation performance are therefore reduced, and moisture resistance is improved.

### BRIEF DESCRIPTION OF DRAWINGS

FIG. 1A schematically shows the structure of a crosslinked material (rubber composition) of Example 1, and FIG. 1B schematically shows the structure of a crosslinked material of Comparative Example 1;

FIG. 2 illustrates a method for measuring a breakdown voltage; and

FIG. 3 is a sectional view of an actuator (or sensor) produced using a crosslinked material (rubber composition) of an example.

### DESCRIPTION OF EMBODIMENTS

### (1) Diene Rubber Containing Hydroxyl Groups

Examples of the diene rubber include, but are not particularly limited to, butadiene rubber (BR), styrene-butadiene rubber (SBR), isoprene rubber (IR), chloroprene rubber (CR), and acrylonitrile-butadiene rubber (NBR).

The hydroxyl groups may be present at molecular ends of the diene rubber or may be added by grafting.

### (2) Polyrotaxane Containing Hydrocarbon-Modified Cyclodextrin as Cyclic Molecules

Examples of the cyclodextrin include α-cyclodextrin, β-cyclodextrin, and γ-cyclodextrin.

Examples of the hydrocarbon modification of the cyclodextrin include alkyl group modification and aryl group modification.

Examples of the linear molecules of the polyrotaxane include, but are not particularly limited to, polyethylene glycol (PEG), polypropylene glycol (PPG), polylactic acid, polyisoprene, polyisobutylene, polybutadiene, polytetrahydrofuran, polydimethylsiloxane, polyethylene, polypropylene, polyvinyl alcohol, and polyvinyl methyl ether.

Examples of the stopper groups for the polyrotaxane include, but are not particularly limited to, dinitrophenyl groups, cyclodextrins, adamantane groups, trityl groups, fluoresceins, pyrenes, substituted benzenes (examples of the substituent include alkyl, alkyloxy, hydroxy, halogen, cyano, sulfonyl, carboxyl, amino, and phenyl; there may be one or more substituents), substituted or unsubstituted polynuclear aromatics (examples of the substituent are the same as above; there may be one or more substituents), and steroids. The stopper groups are preferably selected from the group consisting of dinitrophenyl groups, cyclodextrins, adamantane groups, trityl groups, fluoresceins, and pyrenes, and are more preferably adamantane groups or trityl groups.

### (3) Isocyanate

Examples of the isocyanate include, but are not particularly limited to, diphenylmethane diisocyanate (MDI), hexamethylene diisocyanate (HDI), tolylene diisocyanate (TDI), methyl isocyanate (MIC), polyfunctional isocyanate, and aromatic polyfunctional isocyanate.

### (4) Dielectric Sheet

It is preferable that a breakdown voltage (at normal temperature and normal humidity) of the dielectric sheet left in an environment of a temperature of 60° C. and a relative humidity of 90% for one hour be 72 V/μm or more. This is because moisture resistance under high humidity can be satisfied.

### EXAMPLES

Rubber compositions of Examples 1, 2 and compositions of Comparative Examples 1, 2 shown in Table 1 below were prepared and their characteristics were measured. The numerical values in the formulation of Table 1 are shown in grams (g) as will be described later in <4>.

TABLE 1

| | | | | | Comparative | Comparative |
|---|---|---|---|---|---|---|
| | | | Example 1 | Example 2 | Example 1 | Example 2 |
| Formulation | Polyrotaxane | Hydrocarbon-modified | 3.95 | 6.21 | — | |
| | | Polyrotaxane | | | | |
| | | HAPR-g-PCL | — | — | 10.9 | |
| | Crosslinking | Polymeric MDI | 1.94 | — | — | |
| | Agent | Millionate MR-200 | | | | |
| | | HDI Polyisocyanate | — | 8.01 | — | |
| | | Duranate SBL-100 | | | | |
| | | PPG having Terminal | — | — | 27.3 | |
| | | Blocked Isocyanate Groups | | | | |
| | Polymer | Hydroxyl-terminated | 8.74 | 13.77 | — | |
| | | Liquid Polybutadiene | | | | |
| | | PPG 700 Diol | — | — | 2.5 | |
| | | PPG Monool | — | — | 7.2 | |
| | Solvent (Toluene) | | 9.53 | 19.1 | 48 | |
| | Antioxidant Thanox 1726 | | 0.24 | 0.49 | 1 | |
| | Dibutyltin Dilaurate Solution (3 wt %) (Catalyst) | | — | — | 0.8 | |
| | Silicone Additive Solution (Solid content 30 wt %) | | 0.2 | 0.41 | 0.8 | |
| | CARBODILITE V-09 GB Solution (Solid content 30 wt %) | | 0.41 | 0.81 | 1.6 | |
| | Silicone Elastomer Film | | — | — | — | ◯ |
| Characteristics | Initial Elastic Modulus (MPa) | Target value: 1 to 3 | 2.9 | 2.8 | 1 | 1.2 |
| | Hysteresis Loss (%) | Target value: 10 or less | 5.5 | 1 or less | 2.4 | 2 |
| | Relative Permittivity (ε) | Target value: 4 or more | 4 | 4.5 | 7.7 | 3 |
| | Initial Breakdown Voltage (V/μm) | Target value: 72 or more | 127.2 | 124 | 69.3 | 120 |
| | Breakdown Voltage for | Target value: 72 or more | 89.6 | 73 | 46.6 | 100 |
| | Crosslinked Material left | | | | | |
| | under high humidity (V/μm) | | | | | |
| | Volume Resistance (Ω/mm) | Target value: | 3.05E+13 | 5.80E+12 | 1.00E+12 | 1.00E+14 |
| | | 4E+12 or more | | | | |

Details of the examples and the comparative examples will be given in the following order. The present invention is not limited to the examples.
<1> Polyrotaxane
<2> Crosslinking agent
<3> Polymer
<4> Preparation of crosslinked material (rubber composition)
<5> Measurement of characteristics
<6> Production of actuator (or sensor)

### <1> Polyrotaxane

### <1-1> For Examples: Synthesis of Hydrocarbon-Modified Polyrotaxane

First, adamantane polyrotaxane (APR) composed of PEG (average molecular weight: 35,000) as linear molecules, α-cyclodextrin as cyclic molecules, and adamantane groups as stopper groups was prepared by the method described in WO 2008/108411 (Patent Document 2).

Next, hydroxypropylated polyrotaxane (HAPR) obtained by modifying the prepared APR with hydroxypropyl groups was prepared by the method described in Patent Document 2.

The weight average molecular weight Mw of the prepared HAPR was 120,000 as measured by gel permeation chromatography (GPC). Nuclear magnetic resonance (NMR) analysis showed that 48% of the hydroxyl groups of the cyclodextrin had been replaced with hydroxypropyl groups.

Thereafter, 10 g of the prepared HAPR and 40 ml of dimethylacetamide were placed and dissolved in a reactor, and 6 ml of triethylamine was further added while stirring. After slowly dropping 9.6 ml of myristoyl chloride while cooling the reactor with water, the reaction was continued for 15 hours. The resultant solution was reprecipitated in deionized water, and the solid was washed with deionized water several times and then dried under reduced pressure in a dryer at 80° C. 54.0 g of toluene was added to 13.5 g of the resultant viscous solid, and the viscous solid was dissolved in the toluene to obtain 67.5 g of a hydrocarbon-modified polyrotaxane solution (solution with a solid content of 20 wt %) in which α-cyclodextrin that is cyclic molecules had myristic acid ester groups.

GPC analysis of the obtained hydrocarbon-modified polyrotaxane solution showed that the weight average molecular weight Mw of the hydrocarbon-modified polyrotaxane was 251,000. The measured hydroxyl value was 19.1 mg KOH/g.

### <1-2> For Comparative Example 1: Synthesis of HAPR-g-PCL

First, a polyrotaxane modified with hydroxypropyl groups (HAPR) disclosed in WO 2005/080469 (Patent Document 1) was prepared as a polyrotaxane containing a cyclodextrin as cyclic molecules, PEG as linear molecules, and stopper groups at both ends of the linear molecules.

Next, a polyrotaxane having caprolactone groups was prepared by the following method in order to obtain solubility and compatibility. 10 g of the above HAPR was placed in a three-necked flask, and 45 g of ε-caprolactone was introduced therein while slowly flowing nitrogen. After uniformly stirring at 100° C. for 30 minutes with a mechanical stirrer, the reaction temperature was raised to 130° C., 0.32 g of tin 2-ethylhexanoate (50 wt % solution) diluted with toluene in advance was added, and the resultant solution was reacted for five hours. The solvent was removed from the solution to obtain 55 g of a polyrotaxane having caprolactone groups (HAPR-g-PCL).

GPC analysis of the obtained HAPR-g-PCL showed that the weight average molecular weight Mw was 580,000 and the molecular weight distribution Mw/Mn was 1.5.

### <2> Crosslinking Agent

### <2-1> Polymeric MDI

Polymeric MDI made by Tosoh Corporation, trade name “Millionate MR-200,” was used.

### <2-2> HDI Polyisocyanate

HDI polyisocyanate made by Asahi Kasei Corporation, trade name “Duranate SBL-100,” was used.

### <2-3> Preparation of PPG Having Terminal Blocked Isocyanate Groups

PPG 700, Diol Type (500 g, made by FUJIFILM Wako Pure Chemical Corporation) and PLACCEL M (430 g, made by Daicel Corporation) that is an ε-caprolactone monomer were added to a three-necked eggplant flask, and then stirred under a nitrogen stream in an oil bath at 110° C. for two hours. After heating the oil bath to 130° C., tin 2-ethylhexanoate (0.5 g, made by Aldrich) was added and stirred for 10 hours to obtain PPG grafted with polycaprolactone at both ends (oligomer 1).

The oligomer 1 (100 g) was added to the three-necked eggplant flask, and then stirred under a nitrogen stream in an oil bath at 90° C. TAKENATE 600 (7.45 g, made by Mitsui Chemicals, Inc.) was slowly added dropwise to the resultant solution over one hour, and then further stirred for two hours to obtain oligomer 2.

TAKENATE 600 (16.66 g) was added to the three-necked eggplant flask, and then stirred under a nitrogen stream in an oil bath at 90° C. A solution of the oligomer 2 (80 g) in toluene (80 g) was slowly added dropwise to the resultant solution over two hours, and then further stirred for two hours. After the reaction, the solution temperature was reduced to 40° C., and 2-butanone oxime (10.95 g, made by Tokyo Chemical Industry Co., Ltd.) was slowly added dropwise so that the solution temperature would not become higher than 60° C. After adding 2-butanone oxime dropwise, the resultant solution was stirred at 40° C. for five hours to obtain a solution of a crosslinking agent containing PPG (PPG 3200) having terminal blocked isocyanate groups (Mn: 5422).

### <3> Polymer

### <3-1> Hydroxyl-Terminated Liquid polybutadiene

Hydroxyl-terminated liquid polybutadiene made by Idemitsu Kosan Co., Ltd. and given by the following chemical formula 1, trade name “Poly bd R-15HT,” was used.

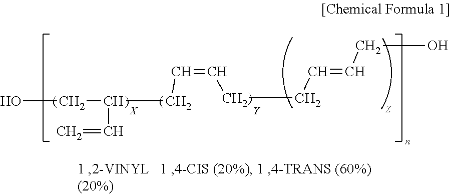

### <3-2> PPG 700 Diol

The above PPG 700, Diol Type (made by FUJIFILM Wako Pure Chemical Corporation) was used.

### <3-3> PPG Monool

Poly (propylene glycol) monobutyl ether (Mn: 1000) (made by Sigma-Aldrich) was used.

### <4> Preparation of Crosslinked Material (Rubber Composition)

### <4-1> Preparation of Example 1

A crosslinking agent solution containing 3.95 g of the hydrocarbon-modified polyrotaxane obtained in <1-1>, 1.94 g of the crosslinking agent (Millionate MR-200) in <2-1>, and 8.74 g of the polymer (Poly bd R-15HT) in <3-1> was dissolved in a solvent and stirred to obtain a uniform solution.

0.24 g of an antioxidant, 0.2 g of a silicone additive (a solution prepared by dissolving DBL-C31 (made by Gelest, Inc.) in toluene and adjusting the solid content to 30 wt %), and 0.41 g of a CARBODILITE V-09 GB solution were added to this solution and stirred to obtain a uniform solution. After defoaming the obtained solution, the resultant solution was formed into a sheet. The sample thus obtained was processed into a crosslinked material (elastomer) under reduced pressure and high temperature conditions.

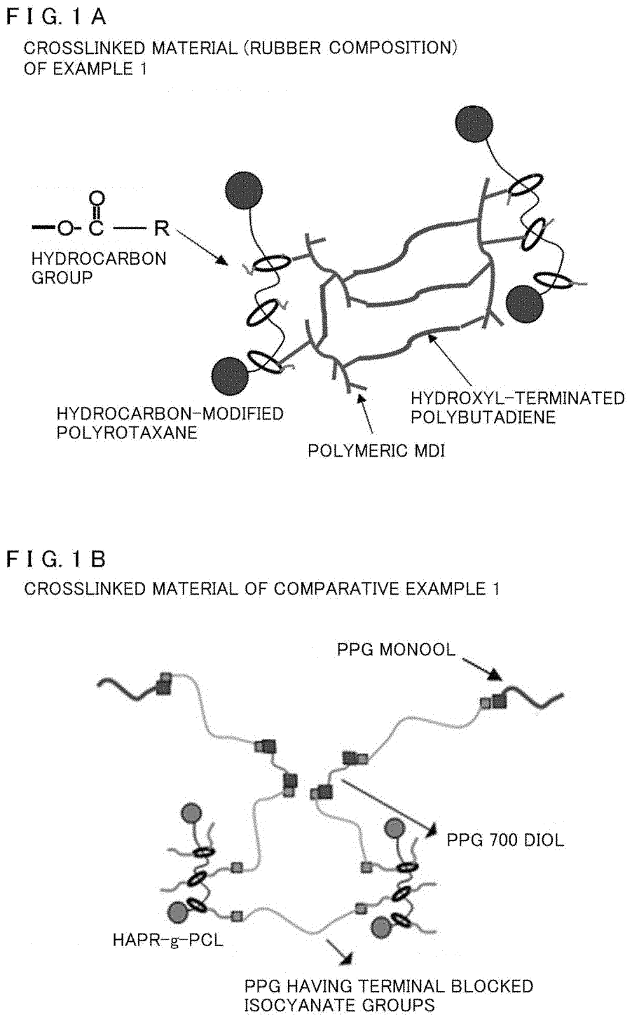

The structure of the obtained crosslinked material (rubber composition) is schematically shown in FIG. 1A.

### <4-2> Preparation of Example 2

A crosslinking agent solution containing 6.21 g of the hydrocarbon-modified polyrotaxane obtained in <1-1>, 8.01 g of the crosslinking agent (Duranate SBL-100) in <2-2>, and 13.77 g of the polymer (Poly bd R-15HT) in <3-1> was dissolved in a solvent and stirred to obtain a uniform solution.

0.49 g of an antioxidant, 0.41 g of the above silicone additive, and 0.81 g of a CARBODILITE V-09 GB solution were added to this solution and stirred to obtain a uniform solution.

After defoaming the obtained solution, the resultant solution was formed into a sheet. The sample thus obtained was processed into a crosslinked material (elastomer) under reduced pressure and high temperature conditions.

### <4-3> Preparation of Comparative Example 1

10.9 g of the HAPR-g-PCL obtained in <1-2> and 27.3 g of a crosslinking agent solution containing the crosslinking agent (PPG 3200) obtained in <2-3> were dissolved in a solvent and stirred to obtain a uniform solution.

0.8 g of a dibutyltin dilaurate solution (3 wt %), 0.8 g of a silicon additive, 1.6 g of a hydrolysis inhibitor, and 1.0 of an antioxidant were added to this solution and stirred to obtain a uniform solution. After defoaming the obtained solution, the resultant solution was formed into a sheet. The sample thus obtained was processed into a crosslinked material (elastomer) under reduced pressure and high temperature conditions.

The structure of the obtained crosslinked material is schematically shown in FIG. 1B.

### <4-4> Comparative Example 2

Evaluation was carried out using a silicone elastomer film made by Wacker Chemie AG, trade name “ELASTOSIL Film 2030” (thickness: 50 μm).

### <5> Measurement of Characteristics

The following characteristics were measured for Examples 1, 2 and Comparative Examples 1, 2. The measurement results are shown in Table 1.

### <5-1> Initial Elastic Modulus

Dumb-bell type-7 pieces were cut out as measurement samples from the crosslinked material according to JIS K 6251. For each sample, a stress-displacement (elongation) curve was measured at a tensile speed of 100 mm/minute with an effective tensile length of 20 mm using Autograph AGS-5kNX made by Shimadzu Corporation. An initial elastic modulus was calculated from the slope obtained by linearly approximating the stress-strain curve from 1 to 5% elongation.

Both Examples 1, 2 and Comparative Examples 1, 2 satisfied target values of the initial elastic modulus that are 1 to 3 MPa.

### <5-2> Hysteresis Loss

As in Patent Document 3 described above, hysteresis loss refers to a mechanical energy loss rate (hysteresis loss) in one cycle of deformation and recovery according to JIS K 6400, using strain of a material that is caused by a tensile test instead of deformation of the material.

Specifically, a dumb-bell type-7 sample (dumb-bell type-7 according to JIS K 6251) is subjected to a tensile test, and a stress-strain curve is measured. After the sample is elongated to 100% of the effective length, it is contracted to 0% at the same rate as the elongation. This cycle was performed 10 times, and the average of the values of the second to tenth cycles was calculated as hysteresis loss by the method for measuring and calculating the area described in Patent Document 3.

Both Examples 1, 2 and Comparative Examples 1, 2 satisfied target values of the hysteresis loss that are 10% or less.

### <5-3> Relative Permittivity

Platinum was deposited on each sample using Auto Fine Coater “JEC-3000FC” made by JEOL Ltd. to an inner diameter of 5 mm. Capacitance was measured with “4294A Precision Impedance Analyzer” made by Agilent Technologies, Inc. using a permittivity measurement probe, and relative permittivity was calculated.

Examples 1, 2 and Comparative Example 1 satisfied target values of the relative permittivity that are 4 or more, but Comparative Example 2 did not.

### <5-4> Breakdown Voltage (Breakdown Electric Field Strength)

First, the thickness of an initial crosslinked material within 48 hours after production was measured. Next, as shown in FIG. 2, the initial crosslinked material 1 was attached to a disk electrode 21 on the installation side, and a cylindrical electrode 22 was placed on the crosslinked material 1 so as to leave few air bubbles as possible between the crosslinked material 1 and each electrode 21, 22. Degassing was further performed using a vacuum device. This was placed in a breakdown measuring device under normal temperature and normal humidity, and a voltage was applied between the electrodes 21, 22 by a power supply device 23 so as to achieve a voltage-increasing rate of 10V/0.1 seconds. A breakdown voltage (V/μm) was then obtained from the voltage at the time the current became 1.2 μA or more after the insulated state in which substantially no current flowed. As used herein, the normal temperature is 20±15° C. and the normal humidity is 65±20% (JIS 8703).

Subsequently, the breakdown voltage of the crosslinked material left in a high humidity environment at a temperature of 60° C. and a relative humidity (RH) of 90% for one hour was also obtained at normal temperature and normal humidity by a method similar to that described above.

Examples 1, 2 and Comparative Example 2 satisfied target values of the initial breakdown voltage that are 72 V/μm or more, but Comparative Example 1 did not.

Examples 1, 2 and Comparative Example 2 satisfied target values of the breakdown voltage for a crosslinked material left under high humidity that are 72 V/μm or more, but Comparative Example 1 did not.

### <5-5> Volume Resistance

A gold (Au) electrode was attached to the crosslinked material by sputtering. A fluorine inert liquid was dropped onto a metal surface of a shielding box, and the crosslinked material attached to a resin frame was placed. A guard electrode was placed on the surface of the crosslinked material, a positioning jig was placed on the guard electrode, and volume resistance (Ω/mm) was measured using a microammeter.

Examples 1, 2 and Comparative Example 2 satisfied target values of the volume resistance that are 4E+12 or more, but Comparative Example 1 did not.

### <6> Production of Actuator (or Sensor)

An actuator can be produced using the sheet-like crosslinked material 1 of the example as a dielectric sheet. For example, as shown in FIG. 3, an actuator 10 can be produced by alternately stacking a plurality of the crosslinked materials 1 of the example and electrode layers 2 and then pressing and bonding the crosslinked materials 1 and the electrode layers 2 together. The electrode layers 2 are arranged in a staggered pattern and are divided into two groups: a group that is staggered to one side in the right-left direction, and a group that is staggered to the other side in the right-left direction. When a direct current (DC) voltage is applied with one group serving as a positive electrode and the other group as a negative electrode, the crosslinked materials 1 contract in their thickness direction, and a change in total height of the actuator 10 due to the contraction can be used as a driving displacement.

Similarly, a sensor can also be produced by alternately stacking the crosslinked materials 1 and the electrode layers 2.

The present invention is not limited to the above examples, and can be modified as appropriate without departing from the spirit and scope of the invention.

### REFERENCE SIGNS LIST

1 Crosslinked material

2 Electrode layer

10 Actuator

21 Disk electrode

22 Cylindrical electrode

23 Power supply device

1. A rubber composition in which a diene rubber containing hydroxyl groups and a polyrotaxane containing a hydrocarbon-modified cyclodextrin as cyclic molecules are urethane-crosslinked by an isocyanate that is a crosslinking agent.

2. A dielectric sheet made of the rubber composition according to claim 1.

3. The dielectric sheet according to claim 2, wherein a breakdown voltage at normal temperature and normal humidity of the dielectric sheet left in an environment of a temperature of 60° C. and a relative humidity of 90% for one hour is 72 V/μm or more.

4. An actuator using the dielectric sheet according to claim 2.

5. A sensor using the dielectric sheet according to claim 2.
